(19) United States
(12) Patent Application Publication
(10) Pub. No.: US 2004/0220707 A1
(43) Pub. Date: Nov. 4, 2004

(54) Method, apparatus and system for remote navigation of robotic devices

(76) Inventor: Kim Pallister, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/428,731

(22) Filed: May 2, 2003

(51) Int. Cl. G01C 21/00

(52) U.S. Cl. 701/24; 318/587

(57) ABSTRACT

A robotic device may utilize the processing power, memory/storage and user interface of a personal computer (“PC”) to improve its performance in embodiments of the present invention. Specifically, according to an embodiment, a robotic device may be coupled to a remote PC via a communications link (e.g., a wireless link) and harness the processing power in the remote PC to augment its own capabilities. The device may include various components that gather and transmit data to the PC via the communications link, and the PC may include an interface to accept the data and/or processing capabilities to process the data from the robotic device. Based on the processed data, the PC may determine an action for the device and send appropriate instructions to the device.

### FIELD

The present invention relates to the field of mobile computing, and, more particularly, to a method, apparatus and system for utilizing a remote processing device to navigate robotic devices.

### BACKGROUND

Over the years, robotic devices have been used extensively in a variety of situations. Traditionally, these devices were extremely expensive and used in environments such as factories, to perform detail-oriented, specialized tasks. Recently, however, there has been an effort to expand robotic devices into the lower-end consumer world, to perform household tasks. Relatively inexpensive robotic consumer devices exist currently which may function independently, with little to no human interaction. These devices typically include minimal processing capability and provide a limited set of functionality.

An example of such a low-end, consumer robotic device is a robotic vacuum cleaner that is capable of automatically vacuuming spaces without any human direction. The device may navigate a room using simple sensors and a basic navigation system. Since the device does not perform any significant data processing, it requires minimal processing capabilities, and this in turn enables the device to be produced and sold for a reasonable price.

Although affordable, the device nonetheless has many shortcomings. Most significantly, the robotic vacuum has minimal ability to process information and make ad-hoc decisions, and is forced to rely on its primitive sensors and navigation system to direct its actions. The navigation system has no knowledge of the room that the device is in, or whether the device has covered a particular area already. As a result, the robotic vacuum may display certain inefficiencies such as repeatedly vacuuming certain areas before other areas are vacuumed once. This behavior may result in a shortened battery life, thus rendering the device more expensive to own and operate. To increase efficiency, the device would require additional processing power, which in turn would likely drive up the cost of the device beyond the acceptable price range for typical consumer devices.

### BRIEF DESCRIPTION OF THE DRAWINGS

The present invention is illustrated by way of example and not limitation in the figures of the accompanying drawings in which like references indicate similar elements, and in which:

FIG. 1 illustrates an exemplary system according to an embodiment of the present invention;

FIG. 2 illustrates the various software modules that may exist in Robotic Device 150 according to one embodiment;

FIG. 3 illustrates an example of how information may be pre-processed to identify a floor plan according to one embodiment of the present invention;

FIG. 4 illustrates an exemplary navigation system according to an embodiment of the present invention; and

FIG. 5 is a flow chart illustrating an embodiment of the present invention.

### DETAILED DESCRIPTION

Embodiments of the present invention provide a method, apparatus and system for remote navigation of robotic devices. “Robotic devices” as used herein shall comprise all programmable electronic devices capable of performing one or more predefined tasks on command and/or according to a predefined program, and may further be capable of relocation. Reference in the specification to “one embodiment” or “an embodiment” of the present invention means that a particular feature, structure or characteristic described in connection with the embodiment is included in at least one embodiment of the present invention. Thus, the phrases “in one embodiment”, “according to one embodiment” or the like appearing in various places throughout the specification are not necessarily all referring to the same embodiment.

In one embodiment of the present invention, a robotic device may utilize the processing power, memory/storage and user interface of a remote processing device (e.g., a personal computer (“PC”)) to improve its performance. Specifically, according to an embodiment, a robotic device may be coupled to a remote PC via a communications link (e.g., a wireless link) and harness the processing power in the remote PC to augment its own capabilities. In the example of the robotic vacuum described above, the device may be coupled to a remote PC to improve its navigation system without significantly adding any cost to the device. The device may include various components that gather and transmit data to the PC via the communications link, and the PC may include an interface to accept the data and/or processing capabilities to process the data from the robotic device. Based on the processed data, the PC may determine an action for the device and send appropriate instructions to the device.

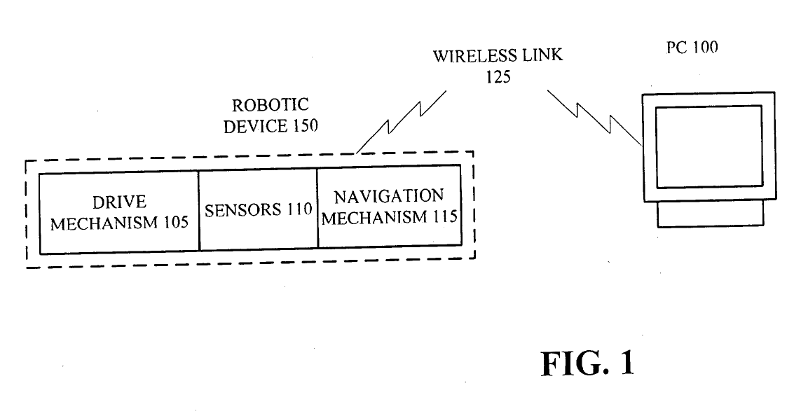

FIG. 1 illustrates an exemplary robotic vacuum system according to an embodiment of the present invention. The system in this embodiment comprises PC 100 and Robotic Device 150. As illustrated, PC 100 may be coupled to Robotic Device 150 via a communications link such as Wireless Link 125, and Robotic Device 150 may comprise Drive Mechanism 105, Sensors 110 and Navigation Mechanism 115. Drive Mechanism 105 may be capable of rotating the device as well as moving the device forward and backward.

In one embodiment, Drive Mechanism 105 may include any device capable of causing Robotic Device 150 to move the device forward and backward predetermined distances (i.e., according to instructions from PC 100, as transmitted to Navigation Mechanism 115) and/or any device capable of rotating Robotic Device 150 a predetermined angle (i.e., according to instructions from PC 100, as transmitted to Navigation Mechanism 115). Drive Mechanism 105 may also include sufficient traction to ensure little to no slippage occurs with typical floor surfaces (e.g., tile, wood, carpet, etc.). According to an embodiment, rubber tires, rubber tracks or other similar schemes may provide traction for Drive Mechanism 105.

In one embodiment, Sensors 110 may comprise a bumper mechanism including a simple contact switch that activates whenever the device contacts an obstacle. Sensors 110 may be placed along the entire length and/or width of Robotic Device 150 such that any contact with the device would always encounter Sensors 110 first. Sensors 110 may additionally comprise one or more other types of sensors (e.g., tactile sensors) placed strategically on Robotic Device 150 to gather data surrounding the device and relay that data to PC 100 for processing. It will be readily apparent to those of ordinary skill in the art that these components (for Drive Mechanism 105 and/or Sensors 110) currently exist and may be easily modified and installed within a vacuum device or other such device, at minimal cost.

Navigation Mechanism 115 may comprise any form of minimal processing system. Navigation Mechanism 115 may be capable of receiving navigation instructions from PC 100, and causing the navigation instructions to be translated into movement of Robotic Device 150. In one embodiment, Navigation Mechanism 115 may comprise a minimal processing device on Robotic Device 150, e.g., the minimal processing device that currently exists on robotic vacuum cleaners. In an embodiment, Drive Mechanism 105 may include Navigation Mechanism 115. It will be readily apparent to those of ordinary skill in the art that a minimal processing device may be used according to embodiments of the present invention because all the significant portions of navigation processing are performed on PC 100, not on Robotic Device 150.

In an embodiment, Wireless Link 125 may comprise any communications link that is capable of supporting two-way communication over a variety of distances. Examples of such two-way communications links include 802.11, Bluetooth and/or cellular links. Wireless Link 125 may comprise a low bandwidth link because the amount of data transferred between Robotic Device 160 and PC 100 is likely to be relatively small and may be transmitted only at infrequent intervals. It will be readily apparent to those of ordinary skill in the art, however, that Wireless Link 125 may in fact comprise any type of link and that the link may be implemented with existing technology without incurring any significant additional cost.

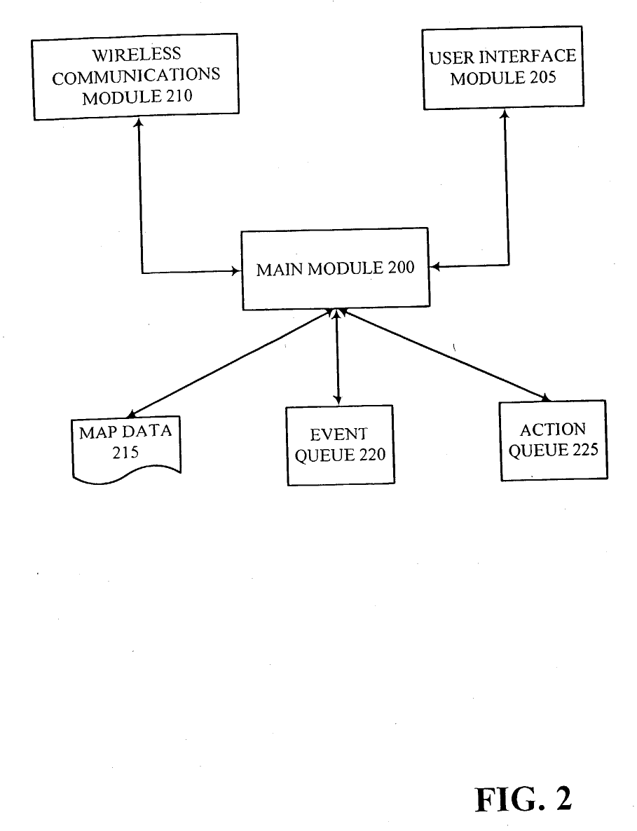

In one embodiment of the invention, the remote navigation scheme on PC 100 may comprise a variety of modules. As illustrated in FIG. 2, Main Module 200 may be communicatively coupled to User Interface Module 205 and Wireless Communications Module 210. Additionally, Main Module 200 may be coupled to Map Data 215, Event Queue 220 and Action Queue 225. In one embodiment, User Interface Module 205 may be implemented on PC 100 to enable the user to specify actions to Robotic Device 150, as well as to monitor the status of Robotic Device 150.

Wireless Communications Module 210 may comprise software that, in conjunction with Wireless Communications Link 125, provides PC 100 and Robotic Device 150 with a communications scheme. Thus, as Robotic Device 150 gathers data pertaining to the room (e.g., via Sensors 110), the data may be transmitted to PC 100 and received by PC 100 via Wireless Communications Module 210. The transmitted data may comprise the data in Event Queue 220, i.e., Event Queue 220 may reside on Robotic Device 150 and also be transmitted to PC 100. Additionally, Action Queue 225 may include a list of actions to be taken by Robotic Device 150, and a copy of Action Queue 225 may also exist on both Robotic Device 150 and PC 100. The list of actions may be actions entered by a user into User Interface Module 205 and/or obtained by Robotic Device 150 via its “learning” capabilities. The device learning capabilities are described in further detail herein. Upon pre-processing the various data received from Robotic Device 150, PC 100 may generate Map Data 215 (described further below). Alternatively, Map Data 215 may be provided to PC 100 by a user via User Interface Module 205.

It will be readily apparent to those of ordinary skill in the art that although robotic devices today may include certain components that gather data for the device, currently available devices have a minimal capacity to process and use this data to navigate the devices. Additionally, as described above, increasing the processing power on the device would raise the cost of the device. Thus, according to an embodiment of the present invention, Robotic Device 150 may comprise minimal processing power and instead leverage the remote processing capacity of any remote processing device (e.g., a PC) capable of communicating with the device. In the above-described embodiments, PC 100 may provide the processing power necessary for Main Module 200 to process the information in Event Queue 220 and Action Queue 225 to determine Robotic Device 150's current location, the next course of action and/or the overall status of Robotic Device 150.

Additionally, in one embodiment, Main Module 200 may pre-process a floor plan for a specified space for future navigation. In this embodiment, Main Module 200 may obtain (from a user or otherwise) information pertaining to a floor plan for a space (e.g., a room) and pre-process this information, i.e., use the information to determine a layout of the space, the obstacles within the space, etc. Main Module 200 may also be responsible for estimating the current location of Robotic Device 150 in a space, based on data in Event Queue 220 and other information in Map Data 215.

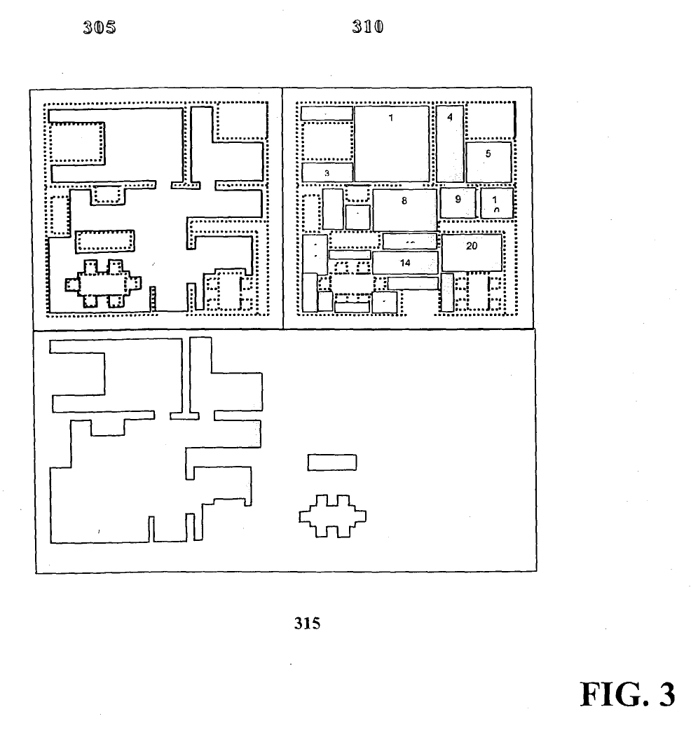

FIG. 3 illustrates an example of Main Module 200 pre-processing information to identify a floor plan according to one embodiment of the present invention. Specifically, an area may be subdivided into convex regions of space that are either empty or occupied. Beginning with a rectangular region comprising the entire area, a determination is made whether each region contains both empty and filled space. If the region does include both empty and filled space, then the region may be divided in half and the process may be repeated. The filled regions may be discarded.

The following pseudo-code describes an example of how a region (Region 1) in 310 above may be described in one embodiment of the present invention:

Begin Region 1

Begin Top Edge

10 foot border with non empty region

End Top Edge
Begin Right Edge

10 foot border with non empty region

End Right Edge
Begin Bottom Edge

1 foot border with non-empty region
3 foot border with empty convex region 8
6 foot border with non-empty region

End Bottom Edge
Begin Left Edge

3 foot border with empty convex region 3
5 foot border with non-empty region
3 foot border with empty convex region 2

End Left Edge

End Region 1

Additionally, although the filled regions may be discarded, all edges of the filled regions may be included in one or more “edge lists,” as illustrated in 305. An exemplary data structure of one or more of the three enclosed edge lists in one embodiment may be as follows:

Begin Edge List 1

15 foot edge
90 degree right turn
10 foot edge
90 degree right turn
2 foot edge
90 degree left turn
1 foot edge
. . .
. . .
. . .
10 foot edge
90 degree turn

End Edge List 1

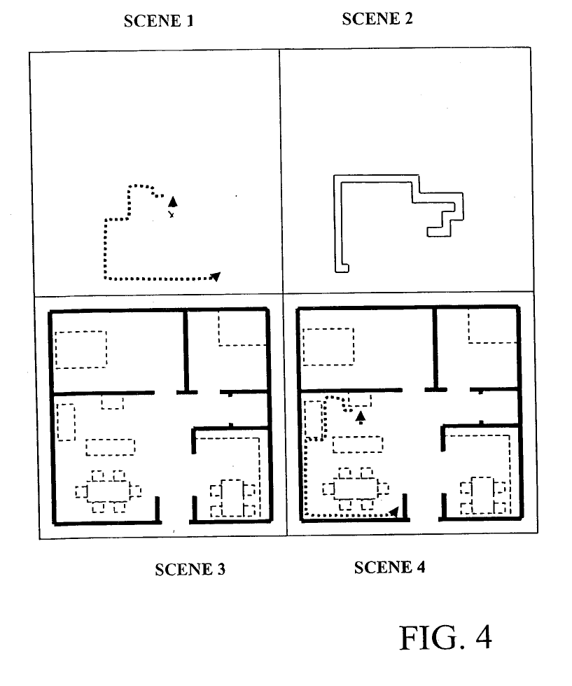

It will be readily apparent to those of ordinary skill in the art that embodiments of the invention are not limited to the above-described details, and that various other implementations may be practiced without departing from the spirit of embodiments of the invention. Regardless of the implementation, once Main Module 200 has pre-processed the data, it may easily determine the location of Robotic Device 150 within an area. In one embodiment, Main Module 200 utilizes event information in conjunction with the pre-processed data to determine this location. More specifically, as illustrated in Scene 1 of FIG. 4, a number of past events in Event Queue 220 may be used to plot a path for Robotic Device 150. In Scene 2, based on the dimensions of Robotic Device 150 (as provided to PC 100 by the user, in one embodiment), Main Module 200 may generate a “path history” of the area traveled by Robotic Device 150. Additionally, in Scene 3, based on information from the user and/or previously pre-processed (described in relation to FIG. 3 above), Main Module 200 may generate and display a floor plan of the space. A user may utilize the floor plan in a variety of ways, including to visually track the progress of Robotic Device 150 and/or to program the navigation system on PC 100 for future navigation of Robotic Device 150 within the same space.

Finally, in one embodiment, in Scene 4, PC 100 may attempt to fit the shape of Robotic Device 150's path history into the empty areas within the floor plan. In the situation where a conclusive location is not possible, Main Module 200 may retrieve additional events from Event Queue 220 and go through the process again until a single matching location is determined. Once Main Module 200 has identified the location of Robotic Device 150 within a space, it may be configured to automatically send instructions to Robotic Device 150 to intelligently navigate around the space.

It will be readily apparent to those of ordinary skill in the art that the above describes merely one embodiment of the present invention. In alternate embodiments, a user may specify the location of Robotic Device 150 in a space, thus enabling PC 100 to simply navigate the device through the space. Additionally, in an embodiment, the first time Robotic Device 150 is placed in a room, PC 100 may gather information from Sensors 110 and Bumper Mechanism 105 to plot the floor plan of the room for subsequent use. Thereafter, upon identifying the location of Robotic Device 150 in a space, PC 100 may easily transmit navigation instructions to the device, to instruct the device to navigate the space. It will also be readily apparent to those of ordinary skill in the art that although Main Module 200 is described herein as a single module, embodiments of the invention may also be implemented with multiple modules that collectively perform the same or similar functionality as Main Module 200.

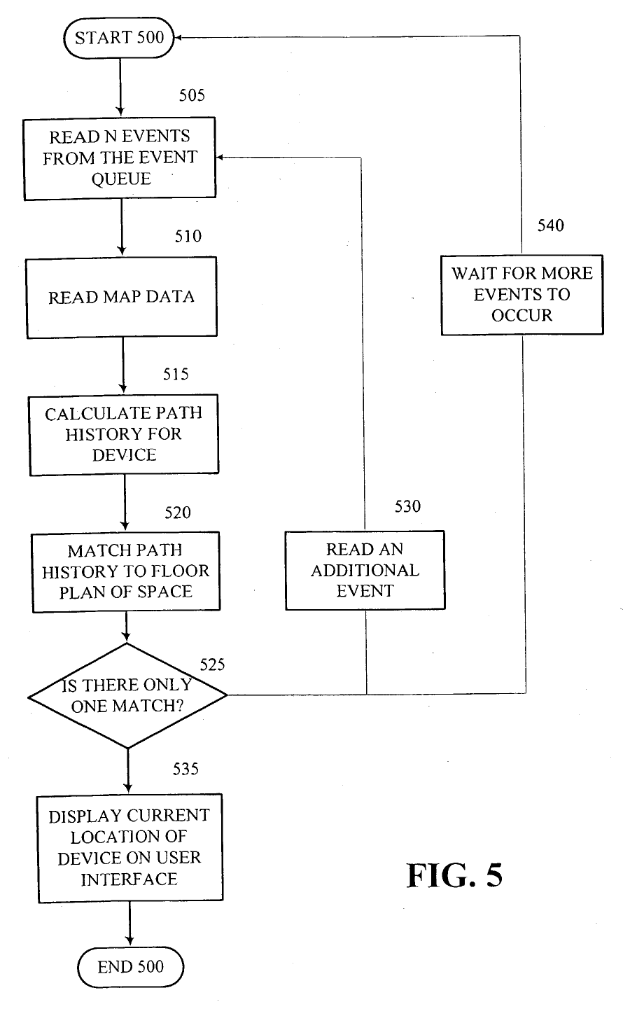

FIG. 5 is a flowchart illustrating an embodiment of the present invention. Specifically, process 500 is an exemplary process for Main Module 200 to determine the location of Robotic Device 150 within a space. In 505, a predetermined number (“N”) of events may be read from Event Queue 220. N may comprise one or more events and may include a minimum number of events to enable PC 100 to determine a location. In various embodiments, N may be defined by a user and/or determined by PC 100 based on previous performance of Robotic Device 150. In 510, information may be read from Map Data 215, and, based on the information from Event Queue 220 and Map Data 215, Main Module 200 may calculate a path history for Robotic Device 150 in 515.

Once a path history has been plotted, it may be matched to a previously provided and/or a pre-processed space layout or floor plan in 520. In 525, if the path polygon matches more than one location in the floor plan, additional events (e.g., “N+1” “N+2” etc.) may be read from Event Queue 220 in 530. Based on the additional event information, a new path history may be calculated and the new path history may again be matched to the space floor plan. This process may be repeated until the calculated path history matches only a single location in the space floor plan. Once there is only a single match (i.e., on the first pass through or subsequent passes) in 525, PC 100 may use the match to identify the current location of Robotic Device 150 in 535, and display the location on User Interface Module 205. PC 100 may also wait for additional events to occur in 540, and continuously update the path history.

Embodiments of the present invention thus leverage the processing capacity of currently available PCs to improve the performance of a variety of robotic devices. Given the increase in the number of home PCs, embodiments of the invention therefore facilitate the availability of more consumer robotic devices at reasonable cost. It will be readily apparent to those of ordinary skill in the art that although robotic devices today may include certain components that gather data for the device, currently available devices have minimal processing capacity. As a result, the devices may only process and utilize a limited set of data. In contrast, in embodiments of the invention, regardless of the limitations of the robotic device, the device may nonetheless achieve a relatively sophisticated navigation system by leveraging the remote processing power of one or more PCs. Additionally, the robotic devices may utilize existing components and/or relatively inexpensive additional components to achieve this result.

Although for the purposes of explanation, the previous description assumes that embodiments of the invention are implemented on a robotic vacuum cleaner, it will be readily apparent to those of ordinary skill in the art that embodiments of the invention are not so limited. Instead, embodiments of the invention may be implemented on a variety of other robotic devices that are designed to navigate around a personal residence or business environment to perform predetermined tasks. For example, a robotic baby monitor and/or toddler monitor may navigate a house to find a child, and then transmit video of the child back to a video display where the parents are present. Alternatively, a robotic “butler” may be capable of fetching mail and/or delivering items from one part of the house to the other. A robotic lawn mower may automatically mow a lawn, while in an office environment, a robotic “mailman” may be used to deliver and pickup mail.

Embodiments of the present invention may be implemented on a variety of robotic devices and in conjunction with a variety of data processing devices. It will be readily apparent to those of ordinary skill in the art that these data processing devices may include various types of software. Thus, for example, in one embodiment, the various modules on PC 100 may comprise software modules. According to an embodiment of the present invention, the data processing devices may also include various components capable of executing instructions (e.g., software instructions) to accomplish an embodiment of the present invention. For example, the data processing devices may include and/or be coupled to at least one machine-accessible medium. As used in this specification, a “machine” includes, but is not limited to, any data processing device with one or more processors. Additionally, as used in this specification, a machine-accessible medium includes any mechanism that stores and/or transmits information in any form accessible by a data processing device, the machine-accessible medium including but not limited to, recordable/non-recordable media (such as read only memory (ROM), random access memory (RAM), magnetic disk storage media, optical storage media and flash memory devices), as well as electrical, optical, acoustical or other form of propagated signals (such as carrier waves, infrared signals and digital signals).

According to an embodiment, a data processing device may include various other well-known components such as one or more processors. The processor(s) and machine-accessible media may be communicatively-coupled using a bridge/memory controller, and the processor may be capable of executing instructions stored in the machine-accessible media. The bridge/memory controller may be coupled to a graphics controller, and the graphics controller may control the output of display data on a display device. The bridge/memory controller may be coupled to one or more buses. A host bus host controller such as a Universal Serial Bus (“USB”) host controller may be coupled to the bus(es) and a plurality of devices may be coupled to the USB. For example, user input devices such as a keyboard and mouse may be included in the data processing device for providing input data.

In the foregoing specification, the invention has been described with reference to specific exemplary embodiments thereof. It will, however, be appreciated that various modifications and changes may be made thereto without departing from the broader spirit and scope of embodiments of the invention, as set forth in the appended claims. The specification and drawings are, accordingly, to be regarded in an illustrative rather than a restrictive sense.

What is claimed is:

1. A method for remote navigation of a robotic device, comprising:
gathering data from at least one component coupled to the robotic device, the data comprising information pertaining to the area surrounding the physical device;
transmitting the data to a remote processing device; and
receiving navigation instructions from the remote processing device.

2. The method according to claim 1 wherein gathering the data from the at least one component comprises gathering the data from at least one of a drive mechanism and a sensor.

3. The method according to claim 1 wherein transmitting the data to the remote processing device comprises transmitting the data to a remote personal computer (PC).

4. The method according to claim 1 wherein the navigation instructions from the remote processing device are determined based at least in part on the data from the robotic device.

5. The method according to claim 1 further comprising performing an action based on the navigation instructions from the remote processing device.

6. A method of remotely navigating a robotic device, comprising:
receiving data from the robotic device;
processing the data to determine a location of the robotic device in an area; and
instructing the robotic device to perform an action based on its location.

7. The method according to claim 6 wherein receiving the data from the robotic device further comprises receiving data pertaining to the surroundings of the robotic device.

8. The method according to claim 7 wherein processing the data to determine the location of the robotic device further comprises:
processing the data pertaining to the surroundings of the robotic device; and
comparing the data with previously obtained information regarding the area.

9. The method according to claim 6 wherein receiving the data from the robotic device further comprises receiving the data from the robotic device via a wireless connection.

10. A system for remote navigation, comprising:
a robotic device;
a remote processing device; and
a communications link capable of coupling the robotic device to the remote processing device, the robotic device capable of transmitting data to the remote processing device via the communications link, and the remote processing device capable of processing the data to determine an appropriate action for the robotic device, the remote processing device further capable of transmitting instructions for the appropriate action to the robotic device via the communications link.

11. The system according to claim 10 wherein the remote processing device is a personal computer (PC).

12. The system according to claim 10 wherein the communications link is a wireless link.

13. The system according to claim 10 wherein the robotic device is one of a robotic vacuum cleaner, a robotic baby monitor, a robotic toddler monitor, a robotic butler, a robotic lawn mower and a robotic mailman.

14. The system according to claim 10 wherein the robotic device further comprises at least one of a drive mechanism and a sensor.

15. The system according to claim 10 wherein the remote processing device includes at least one of a user interface, a communications module and a main processing module capable of maintaining an event queue and an action queue.

16. An article comprising a machine-accessible medium having stored thereon instructions that, when executed by a machine, cause the machine to:
gather data from at least one component coupled to the robotic device, the data comprising information pertaining to the area surrounding the physical device;
transmit the data to a remote processing device; and
receive navigation instructions from the remote processing device.

17. The article according to claim 16 wherein the instructions, when executed by the machine, further cause the machine to gather the data from at least one of a drive mechanism and a sensor.

18. The article according to claim 16 wherein the instructions, when executed by the machine, further cause the machine to transmit the data to a remote personal computer (PC).

19. The article according to claim 16 wherein the navigation instructions from the remote processing device are determined based at least in part on the data from the robotic device.

20. The method according to claim 16 wherein the instructions, when executed by the machine, further cause the machine to perform an action based on the navigation instructions from the remote processing device.

21. An article comprising a machine-accessible medium having stored thereon instructions that, when executed by a machine, cause the machine to:
receive data from the robotic device;
process the data to determine a location of the robotic device in an area; and
instruct the robotic device to perform an action based on its location.

22. The article according to claim 21 wherein the instructions, when executed by the machine, further cause the machine to receive data pertaining to the surroundings of the robotic device.

23. The article according to claim 22 wherein the instructions, when executed by the machine, further cause the machine to:
process the data pertaining to the surroundings of the robotic device; and
comparing the data with the area information.

24. The article according to claim 21 wherein receiving the data from the robotic device further comprises receiving the data from the robotic device via a wireless connection.

25. A robotic device, comprising:
a drive mechanism;
a sensor; and
a communications link capable of coupling the robotic device to a remote processing device, the communications link capable of transmitting data from the sensor to the remote processing device, the communications link further capable of receiving navigation instructions from the remote processing device.

26. The robotic device according to claim 25 wherein the navigation instructions from the remote processing device are determined based on the data transmitted from the robotic device to the remote processing device.

27. The robotic device according to claim 26 wherein the navigation instructions instruct the drive mechanism of the robotic device how to navigate an area.

28. The robotic device according to claim 25 wherein the remote processing device includes a personal computer (PC).

29. The robotic device according to claim 25 wherein the communications link includes a wireless communications link.

30. The robotic device according to claim 25 wherein the data from the sensor includes data pertaining to the surroundings of the robotic device.
